(19) United States
(12) Patent Application Publication
(10) Pub. No.: US 2023/0347477 A1
(43) Pub. Date: Nov. 2, 2023

(54) CLAMP HOLDER APPARATUS, SYSTEM AND METHOD THEREOF

(71) Applicant: Woodpeckers, LLC, Strongsville, OH (US)

(72) Inventor: Izzy Swan, Greenville, SC (US)

(73) Assignee: Woodpeckers, LLC, Strongsville, OH (US)

(21) Appl. No.: 18/163,691

(22) Filed: Feb. 2, 2023

Related U.S. Application Data
(60) Provisional application No. 63/337,291, filed on May 2, 2022.

(51) Int. Cl. B25B 5/00

(52) U.S. Cl. CPC B25B 5/006

(57) ABSTRACT

An apparatus is provided that may include clamp alignment members, and interconnection members connecting each of the clamp alignment members. The clamp alignment members each have a slot disposed between a first end and a second end thereof. Each interconnection member is pivotably coupled to another interconnection member and slidably coupled with respect to one of the clamp alignment members via one of the slots.

### CROSS REFERENCE TO RELATED APPLICATIONS

This application claims the benefit of U.S. Provisional Application Serial Number 63/337,291, filed on May 2, 2022; the disclosure of which is incorporated herein by reference.

### TECHNICAL FIELD

This disclosure is directed to clamps, and more particularly, to clamp holder systems.

### BACKGROUND ART

Clamping can refer to the process of using mechanical fasteners, commonly referred to as clamps, to hold a workpiece in place. Clamps are used in many fields, such as carpentry, woodworking, furniture making, welding, construction, metal working, etc., to hold a workpiece securely in place while a user is working on the workpiece. Clamps can allow the workpieces to be secured in place and held together and help ensure that the workpieces are properly aligned while a user works on the workpiece. For example, clamps are commonly used in the woodworking field to hold multiples pieces of wood together securely and/or in fixed position relative to each other so that a user can work on a workpiece. This can help ensure the workpiece does not move during drilling, chiseling, assembling, or gluing the workpiece together, for example.

A given workpiece may have a complex structure and vary in size, shape and other aspects. As such, there are several different types of clamps that are commercially available in a wide range of sizes and configurations. Each type of clamp can have its own characteristics, structural features, etc. Some examples of clamps used in woodworking include parallel clamps, bar clamps, toggle clamps, spring clamps, C-style clamps, F-style clamps, G-style clamps, pipe clamps, etc. The type of clamp that is selected for a particular project can vary depending on the workpiece that is being secured. Ideally, clamps should not be affected by things like vibration, chatter or heavy pressure, and should not damage or deform the workpiece due to movement.

Conventional clamps often do not have supporting regions. In addition, when using multiple clamps to secure a workpiece, a user normally may need to move, set and adjust each clamp individually (e.g., one at a time). This increases the time and effort required to apply clamps to a given workplace, or to adjust them while working on the workpiece. As such, the process of clamping can require many individual adjustments by the user during the process of using them. This may require a lot of effort and can be time consuming for the user.

To help address one or more of these issues, clamp holder systems have been developed. Existing clamp holder systems often suffer from a variety of drawbacks. Accordingly, it would be desirable to provide an improved clamp holder system.

### SUMMARY OF THE INVENTION

A clamp holder system is provided that includes a plurality of clamp alignment members and a plurality of interconnection members connecting each of the plurality of clamp alignment members. Each of the plurality of clamp alignment members includes a slot disposed between a first end and a second end. Each interconnection member may be pivotably coupled to another interconnection member of the plurality of interconnection members. Each of the plurality of interconnection members may be slidably coupled with respect to one of the plurality of clamp alignment members via one of the slots.

In another aspect, a plurality of clamp holders disposed along at least one of the plurality of clamp alignment members. In another aspect, the slot may be a first slot, and wherein each of the plurality of clamp alignment members further includes: a second slot. The plurality of clamp holders may include a movable clamp holder slidably coupled within the second slot at each of the clamp alignment members. In another aspect, the plurality of clamp holders further include a fixed clamp holder coupled to each of the plurality of the clamp alignment members.

In another aspect, each of the movable clamp holder and the fixed clamp holder may include a clamp holder portion including a pair of sidewall portions that are spaced apart to define a recess within the clamp holder portion, a supporting portion, and a fastener that extends through the supporting portion and the second slot into the clamp holder portion to couple the supporting portion to the clamp holder portion. The recess may be configured to receive a clamp and elevate the clamp at a distance above a first surface of a clamp alignment member that it may be coupled to. The clamp holder portion may be configured to receive one or more adjustable set screws to fasten the clamp that is received in a fixed position within the clamp holder portion.

In another aspect, each interconnection member of the plurality of interconnection members may further include a first aperture formed therein for coupling that interconnection member to one of the clamp alignment members via a fastener.

In another aspect, the position of each movable clamp holder may be adjustable along the first slot to move the clamp holder in an axial direction of a clamp alignment member that the movable clamp holder is coupled to. Each interconnection member may be pivotably coupled to an end portion of a clamp alignment member to allow the interconnection member to rotate with respect to a longitudinal axis of that clamp alignment member. In another aspect, each of the plurality of interconnection members may be slidably coupled with respect to one of the plurality of clamp alignment members via one of the slots such that movement of the clamp alignment members in a first direction results in expansion of the clamp holder system and movement of the clamp alignment members in a second direction, opposite the first direction, results in retraction of the clamp holder system.

An apparatus is provided that includes a plurality of interconnection members and a plurality of clamp alignment members coupled to each other via the plurality of interconnection members. Each interconnection member may be translatably coupled to one of the clamp alignment members and rotatably coupled to one of the clamp alignment members.

In another aspect, each one of the clamp alignment members includes a slot formed therein along an axial direction of the clamp alignment member. One end of each interconnection member may be rotationally and translatably coupled to one of the clamp alignment members via a fastener disposed in a slot of the one of the clamp alignment members that it is coupled to.

In another aspect, the fastener may be a first fastener that is translatably coupled for movement within the slot formed in one of the clamp alignment members to allow for movement of that first fastener and the interconnection member along an axis defined by one of the clamp alignment members that it is coupled to. Each of the plurality of clamp alignment members may include a first end, a second end and a second slot formed therein. Another end of each interconnection member may be rotatably coupled to the second end of one of the clamp alignment members through a second fastener.

In another aspect, the plurality of interconnection members may be configured to be movable between a first position and a second position. The first position corresponds to an expanded position of the apparatus and the second position corresponds to a retracted position of the apparatus in which a separation distance between the clamp alignment members is less than the separation distance between the clamp alignment members when the interconnection members are in the expanded position of the apparatus.

In another aspect, a plurality of clamp holders may be coupled to at least one of the clamp alignment members. In another aspect, each one of the clamp alignment members includes a slot formed therein along an axial direction of the clamp alignment member. The plurality of clamp holders may include a first clamp holder for each of the clamp alignment members. Each first clamp holder may be coupled to a slot of the clamp alignment member that it may be coupled to.

In another aspect, a position of the first clamp holder may be adjustable within the slot of the clamp alignment member that it may be coupled to. The plurality of clamp holders may further include a second clamp holder coupled to each one the clamp alignment members. The first clamp holder may be movable and the second clamp holder may be fixed.

In another aspect, the slot may be referred to as a first slot, and each of the clamp alignment members further includes a second slot formed therein. The first clamp holder and the second clamp holder may include a clamp holder portion, a supporting portion, and a fastener that extends through the supporting portion and the second slot into the clamp holder portion to couple the supporting portion to the clamp holder portion.

In another aspect, each interconnection member may be rotatably coupled to another interconnection member to form an interconnection member pair. Each interconnection member of an interconnection member pair may be pivotably coupled to the other interconnection member of that interconnection member pair to allow for rotation of the interconnection members relative to each other.

Another embodiment may provide an apparatus that includes a first clamp alignment member having a first slot formed therein, a second clamp alignment member having a second slot formed therein, a first interconnection member slidably coupled to the first clamp alignment member via the first slot, and a second interconnection member pivotably coupled to the first interconnection member and slidably coupled to the second clamp alignment member via the second slot. In another aspect, the apparatus may further include a plurality of clamp holders disposed along the first and second clamp alignment members.

In yet another aspect, another exemplary embodiment of the present disclosure may provide a method for an apparatus for holding clamps, the apparatus having a plurality of interconnection members and a plurality of clamp alignment members coupled to each other via the plurality of interconnection members, wherein each interconnection member is translatably coupled to one of the clamp alignment members and rotatably coupled to an adjacent one of the clamp alignment members, the method comprising: coupling a first clamp to a first clamp alignment member; coupling a second clamp to a second clamp alignment member; moving the first clamp and the second clamp from a first position to a second position, wherein moving the first clamp and the second clamp relative to one another is accomplished by translating a first end of a first interconnection member in an axial direction relative to the first clamp alignment member and rotating a second end of the first interconnection member relative to the second clamp alignment member; and clamping an item (such as a wooden workpiece) with the first clamp and the second clamp after having moved the first clamp and the second clamp from the first position to the second position. This exemplary embodiment or another exemplary embodiment may further provide for sliding a fastener at the first end of the first interconnection member within a slot defined in the first clamp alignment member. This exemplary embodiment or another exemplary embodiment may further provide for moving a second interconnection member in a scissoring action relative to the first interconnection member. This exemplary embodiment or another exemplary embodiment may further provide for translating a first end of the second interconnection member in an axial direction relative to the second clamp alignment member and rotating a second end of the second interconnection member relative to the first clamp alignment member.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is an isometric perspective top view of an embodiment of a clamp holder system in accordance with an aspect of the present disclosure;

FIG. 2A (FIG. 2A) is an enlarged isometric perspective top view of the region labeled “SEE FIG. 2A” in FIG. 1 depicting a portion of a clamp alignment member and a clamp holder of the clamp holder system;

FIG. 2B (FIG. 2B) is an exploded isometric perspective top view of the portion of the clamp alignment member and the clamp holder of FIG. 2A;

FIG. 2C (FIG. 2C) is cross sectional view of the clamp holder of FIG. 2A taken along line 2C-2C in FIG. 2A;

FIG. 3A (FIG. 3A) is an enlarged isometric perspective top view of the region labeled “SEE FIG. 3A” in FIG. 1 depicting a clamp alignment member, interconnection members and a first fastener of the clamp holder system of FIG. 1;

FIG. 3B (FIG. 3B) is an exploded isometric perspective top view of the fastener, the clamp alignment member, the interconnection member and the interconnection member of FIG. 3A;

FIG. 4 (FIG. 4) is an top plan view of an embodiment of the clamp holder system in accordance with an aspect of the present disclosure;

FIG. 5 (FIG. 5) is a elevation view of a portion of the clamp holder system including clamp holders, a clamp alignment member, and interconnection members taken along line 5-5 in FIG. 4;

FIG. 6A (FIG. 6A) is an operational top plan view of the clamp holder system of FIG. 1 when it is in a fully retracted position and is expandable;

FIG. 6B (FIG. 6B) is an operational top plan view of the clamp holder system of FIG. 1 when it is in a fully expanded position and retractable;

FIG. 7A (FIG. 7A) is an isometric perspective top view of a portion of the clamp holder system of FIG. 1 and a clamp that will be engaged by the clamp holder system;

FIG. 7B (FIG. 7B) is an isometric perspective top view of the portion of the clamp holder system that is shown in FIG. 7A with the clamp securely engaged by the clamp holder system; and

FIG. 8 (FIG. 8) is an isometric perspective top view of the clamp holder system of FIG. 1 with a set of clamps engaged by the clamp holder system and being used to clamp a number of wooden pieces together.

Similar numbers refer to similar parts throughout the drawings.

### DETAILED DESCRIPTION

As described above existing clamp holder systems often suffer from a variety of drawbacks. For example, existing clamp holder systems often have complex structures that make them difficult for users to use. Another issue with existing clamp holder systems is that they are often designed to work only with specific types of clamps and may not be able to accommodate different types of clamps, or may not work with clamps having a wide range of different sizes and shapes. This can make it inconvenient for users who work with a variety of different types of clamps, which can in turn limit the workpieces that a clamp holder system can be used with.

Existing clamp holder systems can also be expensive and may require a large amount of space for storage and transport. This can be a significant disadvantage for users who use a variety of different clamps because they may need multiple clamp holder systems and/or may not have the space or budget to accommodate multiple clamp holder systems.

To address some of the above-mentioned drawbacks associated with conventional clamp holder systems, an improved clamp holder system is provided that can be used to hold and lock a number of clamps in place so that they are relatively proportional with respect to each other in an easily adjustable manner. The clamp holder system includes clamp alignment members and interconnection members coupled in a manner that allows the clamp holder system to be expanded or retracted with minimal manual effort. The clamp holder system allows for the spacing between the clamps to be changed or varied in one operation by simply adjusting one or more of the clamp alignment members, or alternatively, by adjusting one or more of the clamp interconnection members. At the same time, the relative spacing between clamps is maintained such that the clamps remain evenly spaced apart. In other words, when the spacing between the clamp alignment members changes (e.g., increases or decreases), the clamp holder system can automatically maintain relatively even spacing between the clamps relative to each other. As such, once clamps are secured by the clamp holder system, minimal adjustments can be made to change the spacing between clamps. Additionally, positions of clamp holders of the clamp holder system can be easily adjusted. This can allow for the speed of clamping operations to be increased significantly and reduce the effort expended by a user when adjusting multiple clamps to secure a workpiece. Since the clamp holder system can be collapsed (e.g., retracted or compressed) while the clamps are installed within the system, it also allows for tangle free storage of clamps and is easily portable.

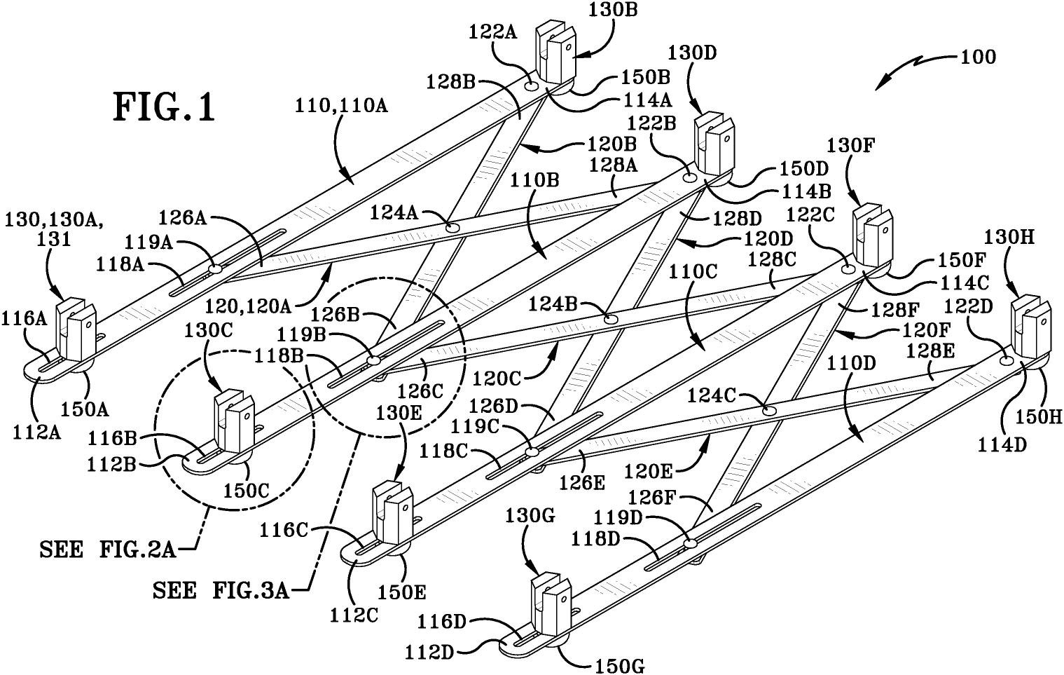

Additionally, the clamp holder system is designed to accommodate many different types of clamp holders. In some embodiments, the clamp holders are removable attachments that can be swapped out (e.g., depending on the type of clamp to be held) to allow the clamp holder system to be used with multiple different types and sizes of clamps. For example, different clamp holders can be designed to hold different types of clamps (e.g., parallel jaw clamps, bar clamps, toggle clamps, spring clamps, C-style clamps, F-style clamps, G-style clamps, pipe clamps). The clamp holders can be removed and replaced with different clamp holders that are more suitable for the particular clamps that being used. This allows the clamp holder system to be used with different clamp holders that are designed to work with different types of clamps. Embodiments of the improved clamp holder system will now be described with reference to FIGS. 1-8.

FIG. 1 is an isometric perspective top view of an embodiment of a clamp holder system 100 in accordance with an aspect of the present disclosure. The clamp holder system 100 may include clamp alignment members 110, interconnection members 120 connecting each of the clamp alignment members 110, and any number of clamp holders 130 disposed along and coupled to the clamp alignment members 110.

The clamp alignment members 110A, 110B, 110C, 110D may include end portions or ends 112A, 112B, 112C, 112D, 114A, 114B, 114C, 114D. To distinguish between the two ends 112, 114 of each clamp alignment member 110A, 110B, 110C, 110D, the ends 112, 114 may be referred to as a “first” end 112A, 112B, 112C, 112D and a “second” end 114A, 114B, 114C, 114D.

Each of the clamp alignment members 110A, 110B, 110C, 110D includes a number of slots formed therein. Each of the clamp alignment members 110A, 110B, 110C, 110D may include any number of slots between its respective end portions or ends. For instance, in this non-limiting embodiment, each clamp alignment member 110A, 110B, 110C, 110D includes two slots 116A/118A, 116B/118B, 116C/118C, 116D/118D, respectively, that are disposed between its respective end portions or ends, but it should be appreciated that this embodiment is non-limiting. For example, in other embodiments, each of the clamp alignment members 110A, 110B, 110C, 110D may include a single slot between its respective ends, whereas in other embodiments, each of the clamp alignment members 110A, 110B, 110C, 110D may include more than two slots between its respective ends. To distinguish between the slots, slots 118A, 118B, 118C, 118D may be referred to as “first” slots 118A, 118B, 118C, 118D, whereas slots 116A, 116B, 116C, 116D may be referred to as “second” slots 116A, 116B, 116C, 116D.

Each of the clamp alignment members 110A, 110B, 110C, 110D includes a slot 118A, 118B, 118C, 118D formed therein along a longitudinal direction of the clamp alignment member, and one end 126A, 126B, 126C, 126D, 126E, 126F of each interconnection member 120A, 120B, 120C, 120C, 120D, 120E, 120F is rotationally and translatably coupled to one of the clamp alignment members 110A, 110B, 110C, 110D via the fastener 119A, 119B, 119C, 119D disposed in a corresponding slot 118A, 118B, 118C, 118D of the one of the clamp alignment members 110A, 110B, 110C, 110D that it is coupled to. The fasteners 119A, 119B, 119C, 119D are translatably coupled for movement within the slot 118A, 118B, 118C, 118D to allow for movement of that fastener 119A, 119B, 119C, 119D and the corresponding interconnection member 120A, 120B, 120C, 120C, 120D, 120E, 20F along an axis defined by one of the clamp alignment members 110A, 110B, 110C, 110D that it is coupled to.

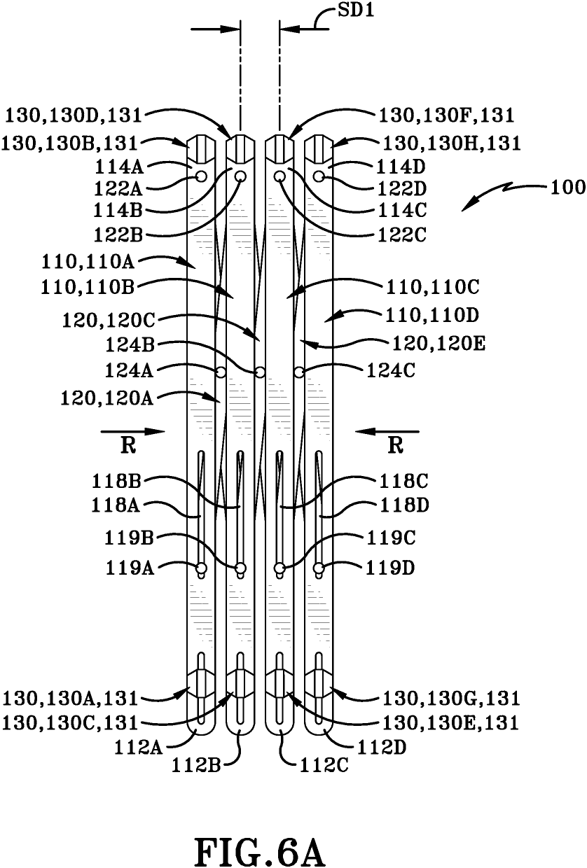

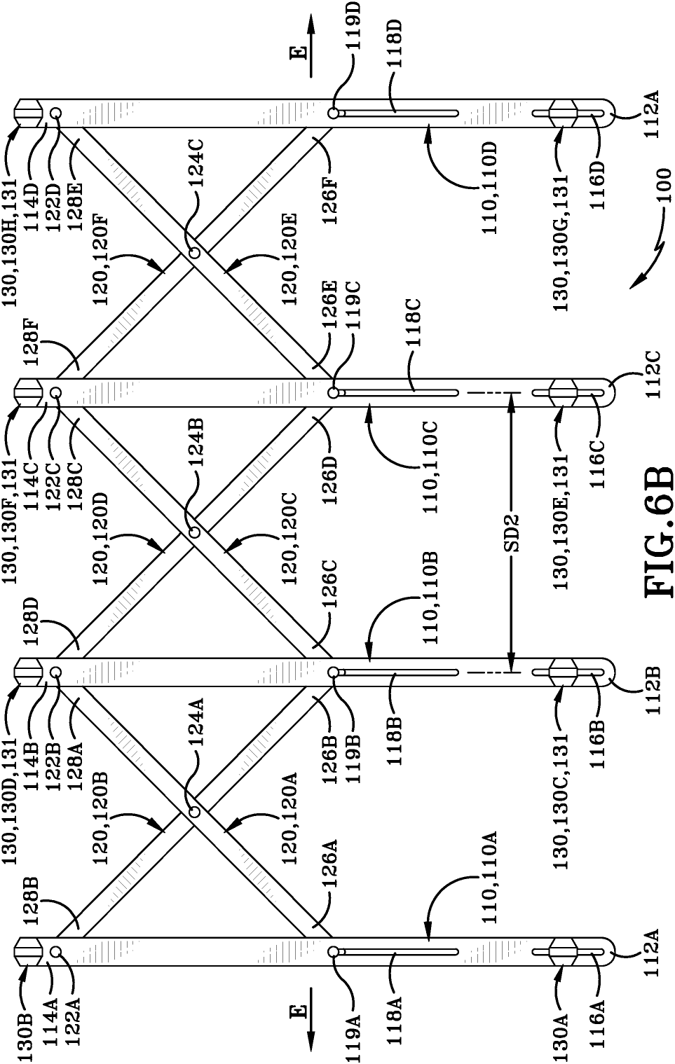

One end 126A, 126B, 126C, 126D, 126E, 126F of each interconnection member 120A, 120B, 120C, 120C, 120D, 120E, 120F may be slidably or translatably coupled with respect to one of the clamp alignment members 110A, 110B, 110C, 110D via a fastener 119A, 119B, 119C, 119D that is disposed within one of the slots 118A, 118B, 118C, 118D of the clamp alignment members 110A, 110B, 110C, 110D such that movement of one or more of the clamp alignment members 110A, 110B, 110C, 110D in a first direction (e.g., direction E of FIG. 6B) results in expansion of the clamp holder system 100, whereas movement of one or more of the clamp alignment members 110A, 110B, 110C, 110D in a second direction e.g., direction R of FIG. 6A), opposite the direction, results in contraction or retraction of the clamp holder system 100, as will be described in greater detail below. As used herein, the term “translatable” may refer to the translation or transitory motion of one end 126A, 126B, 126C, 126D, 126E, 126F of each interconnection member 120A, 120B, 120C, 120C, 120D, 120E, 120F with respect to the longitudinal axis of the one of the clamp alignment members 110A, 110B, 110C, 110D that end 126A, 126B, 126C, 126D, 126E, 126F is coupled to. For example, one end 126A, 126B, 126C, 126D, 126E, 126F of each interconnection member 120A, 120B, 120C, 120C, 120D, 120E, 120F is movably coupled with respect to the longitudinal axis of the clamp alignment members 110A, 110B, 110C, 110D such that the end 126A, 126B, 126C, 126D, 126E, 126F may translate along a longitudinal axial direction or an axis defined by the one of the clamp alignment members 110A, 110B, 110C, 110D that end 126A, 126B, 126C, 126D, 126E, 126F is coupled to.

The other end 128A, 128B, 128C, 128D, 128E, 128F of each interconnection member 120A, 120B, 120C, 120C, 120D, 120E, 120F may be rotatably or pivotably coupled to one of the clamp alignment members 110A, 110B, 110C, 110D via a fastener 122A, 122B, 122C, 122D. For example, end 126A of interconnection member 120A may translate with respect to the longitudinal axis of the clamp alignment member 110A as the fastener 119A moves within slot 118A, whereas the other end 128A of interconnection member 120A, which is rotatably or pivotably coupled to clamp alignment member 110B via a fastener 122B, can rotate or pivot as the clamp alignment members 110A, 110B, 110C, 110D of the clamp holder system 100 are expanded and moved further apart from each other, or as the clamp alignment members 110A, 110B, 110C, 110D of the clamp holder system 100 are retracted (e.g., contracted or compressed) and moved closer to each other.

Although not shown in FIG. 1, each interconnection member 120A, 120B, 120C, 120D, 120E, 120F may also include an aperture or hole formed therein for coupling that interconnection member to one of the clamp alignment members 110A, 110B, 110C, 110D via a fastener 122A, 122B, 122C, 122D. For example, an end 128B of interconnection member 120B may be rotatably or pivotably coupled to an end 114A of clamp alignment member 110A via fastener 122A so that the interconnection member 120B may rotate with respect to a longitudinal axis of that clamp alignment member 110A. This allows the ends 128A, 128B, 128C, 128D, 128E, 128F of each interconnection member 120A, 120B, 120C, 120C, 120D, 120E, 120F to be rotatably coupled to the ends 114A, 114B, 114C, 114D of one of the clamp alignment members 110A, 110B, 110C, 110D via a fastener 122A, 122B, 122C, 122D.

Each interconnection member 120A, 120B, 120C, 120C, 120D, 120E, 120F may be coupled to another interconnection member via a connecting feature 124A, 124B, 124C, such as a barrel bolt, to form an interconnection member pair 120A/120B, 120C/120D, 120E/120F. Each interconnection member pair 120A/120B, 120C/120D, 120E/120F forms a substantially X-shaped configuration at point of intersection where they are coupled together by a corresponding connecting feature 124A, 124B, 124C. Each interconnection member of an interconnection member pair 120A/120B, 120C/120D, 120E/120F may be rotatably or pivotably coupled to another interconnection member of that interconnection member pair to allow for the interconnection members of that interconnection member pair to be rotated or pivoted relative to each other as the clamp holder system 100 is expanded or as it is compressed (e.g., contracted or retracted). In this embodiment, the interconnection members 120A, 120B, 120C, 120C, 120D, 120E, 120F of each interconnection member pair 120A/120B, 120C/120D, 120E/120F may be connected at or near the center of each interconnection member 120A, 120B, 120C, 120C, 120D, 120E, 120F (via a corresponding connecting feature 124A, 124B, 124C). However, it should be appreciated that alternative connection points are possible in other embodiments.

Clamp holders 130 may be disposed along and coupled to the clamp alignment members 110A, 110B, 110C, 110D. The clamp holders 130A, 130B, 130C, 130D, 130E, 130F, 130G, 130H are designed to hold different types of clamps (not illustrated in FIG. 1.) The clamp holder system 100 is designed to accommodate many different types of clamp holders 130. In some embodiments, the clamp holders 130 are removable attachments that can be swapped out (e.g., depending on the type of clamp to be held) to allow the clamp holder system 100 to be used with multiple different types and sizes of clamps. For example, different clamp holders 130 can be designed to hold different types of clamps (e.g., parallel clamps, C-clamps, F-clamps, G-clamps, etc.). The clamp holders 130 can be removed and replaced with different clamp holders (not illustrated) that are more suitable for securing the particular clamps being used. This allows the clamp holder system 100 to be used with different clamp holders that are designed to work with different types of clamps.

Clamp holders 130 may be coupled to the clamp alignment members 110 in a fixed location, or may be coupled to the clamp alignment members 110 in an adjustable manner so that their location can be moved or adjusted. In this embodiment, clamp holders 130B, 130D, 130F, 130H are mounted on or fixed to the clamp alignment members 110A, 110B, 110C, 110D in a relatively fixed location. By contrast, clamp holders 130A, 130C, 130E, 130G are coupled to the slots 116A, 116B, 116C, 116D of the corresponding clamp alignment member 110A, 110B, 110C, 110D that each one is coupled to. As such, in this embodiment, clamp holders 130A, 130C, 130E, 130G are movable. In other words, the position of each clamp holder 130A, 130C, 130E, 130G is movable, slidable or adjustable along or within the first slot 116A, 116B, 116C, 116D. This allows the position of the clamp holders 130A, 130C, 130E, 130G to be moved, slid or adjusted in an axial direction of a corresponding clamp alignment member that each of the clamp holders 130A, 130C, 130E, 130G is coupled to. This may allow for the relative positions of the clamp holders 130A, 130C, 130E, 130G to be moved or slid along the axial direction of their corresponding clamp alignment member so that the position of the clamp holders 130A, 130C, 130E, 130G may be adjusted to better receive or accommodate the clamps (not shown in FIG. 1). Thus, in this embodiment, the positions of clamp holders 130A, 130C, 130E, 130G are movable, slidable or adjustable within the first slot 116A, 116B, 116C, 116D at the first end 112A, 112B, 112C, 112D of the corresponding clamp alignment member 110A, 110B, 110C, 110D that it is coupled to.

In another embodiment, the dimension of the slots 116A, 116B, 116C, 116D may be reduced such that the slots 116A, 116B, 116C, 116D effectively become a hole or aperture that allows for the clamp holders 130A, 130C, 130E, 130G to be mounted in a relatively fixed location so that they are not slidable. In addition, in other embodiments, the slots 116A, 116B, 116C, 116D are not present at all, and the clamp holders 130A, 130C, 130E, 130G may be either part of their respective clamp alignment members 110A, 110B, 110C, 110D and/or permanently fixed at the end portions or ends 112A, 112B, 112C, 112D of their respective clamp alignment members 110A, 110B, 110C, 110D).

Depending on the implementation, the clamp holder system 100 may include any number of clamp alignment members 110, interconnection members 120, and clamp holders 130. As such, although the embodiment of the clamp holder system 100 that is illustrated in FIG. 1 includes four clamp alignment members 110A, 110B, 110C, 110D coupled to each other via six interconnection members 120A, 120B, 120C, 120C, 120D, 120E, 120F, and a total of eight clamp holders 130A, 130B, 130C, 130D, 130E, 130F, 130G, 130H coupled to the clamp alignment members 110A, 110B, 110C, 110D, it should be appreciated that this embodiment is non-limiting and that other configurations are possible. For example, in some embodiments, additional or fewer clamp alignment members, additional or fewer interconnection members, and/or additional or fewer clamp holders may be implemented. In addition, although the embodiment of the clamp holder system 100 that is illustrated in FIG. 1 includes two clamp holders 130A, 130B coupled to each clamp alignment member 110A, it should be appreciated that this embodiment is non-limiting and that the other configurations are possible where additional or fewer clamp holders may be used with each clamp alignment member 110A, 110B, 110C, 110D.

The components of the clamp holder system 100 can be made of one or more metal materials, one or more plastic materials, etc. In one embodiment, the clamp alignment members 110 and the interconnection members 120 may be made of powder coated steel and the clamp holders 130 may be made of a poly carbonate material. Further, the supporting portion 152 can be made of either anti-vibration material or anti-slip material, preferably in nylon, rubber or plastic material, to provide the stability of the clamp holder system 100 and also not to harm the work bench that it is placed on.

The dimensions of the clamp alignment members 110, the interconnection members 120 and the clamp holders 130 can vary depending on the dimensions of the clamps (not illustrated in FIG. 1) that the clamp holder system 100 is designed to accommodate.

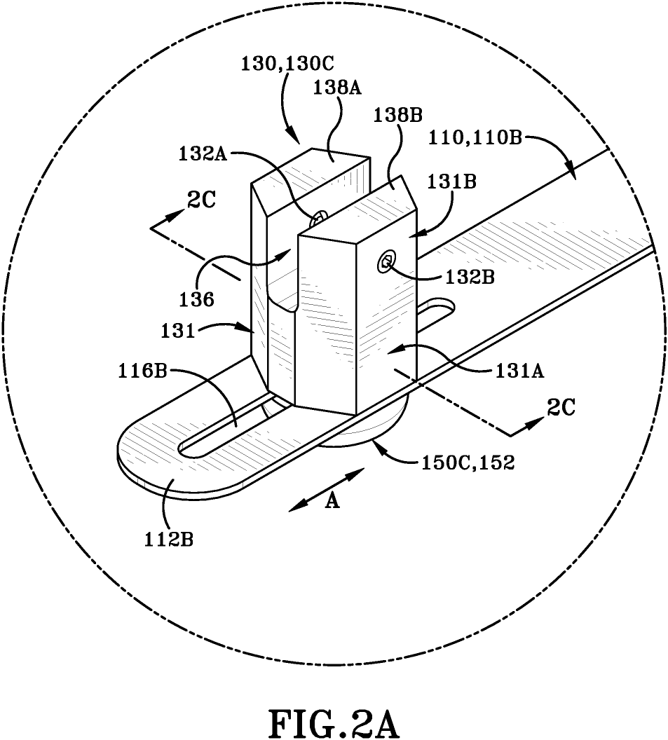

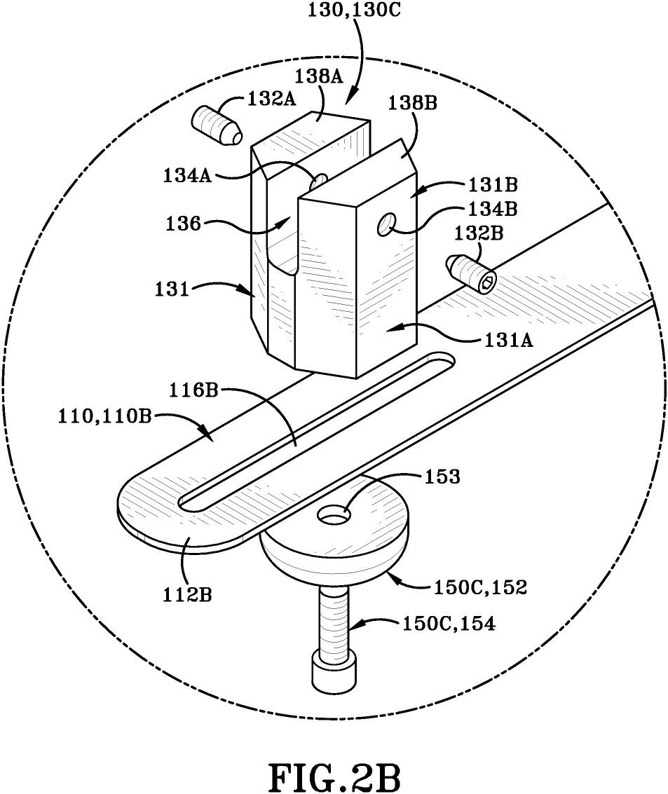

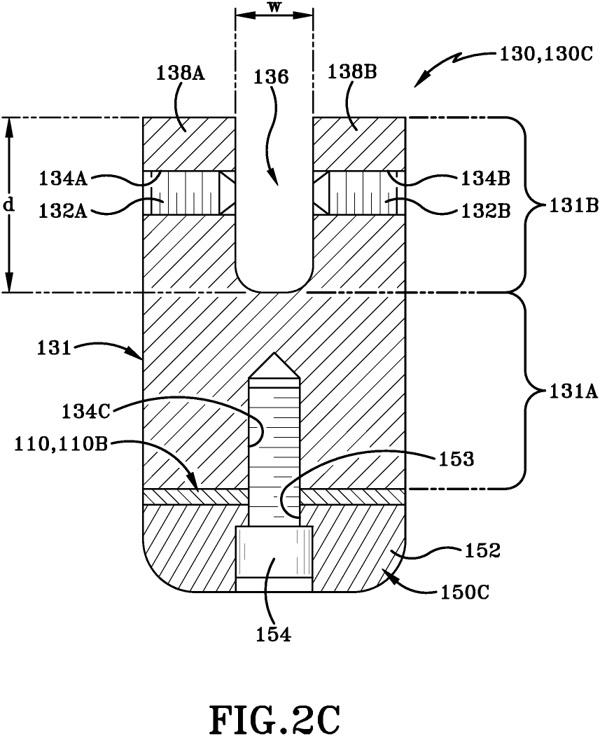

FIG. 2A is an isometric perspective top view of a portion of a clamp alignment member 110B and a clamp holder 130C of the clamp holder system 100 of FIG. 1. FIG. 2B is an exploded isometric perspective top view of the portion of the clamp alignment member 110B and the clamp holder 130C of FIG. 2A. FIG. 2C is cross sectional view of the clamp holder 130C of FIG. 2A taken along line 2C of FIG. 2A. As shown in FIGS. 2A-2C, in this non-limiting embodiment, the clamp holder 130C includes a clamp holder portion 131, a supporting portion 150C and a fastener 154 that is used to secure the supporting portion 152 and the clamp holder portion 131.

In this embodiment, the clamp holder portion 131 includes a lower portion 131A and an upper portion 131B having a channel or recess 136 defined therein by a pair of sidewalls 138A, 138B. The sidewalls 138A, 138B are of equal height in this embodiment, but may be of different heights in other embodiments. The lower portion 131A includes a recess 134C that is configured to align with the slot 116B so that it can receive the fastener 154. The lower portion 131A has a height that allows for the fastener 154 to be accommodated in the recess 134C while also spacing the recess 136 of the upper portion 131B above a surface of the clamp alignment member 110B. The recess 136 that is defined in the upper portion 131B has appropriate dimensions including a width (w) and a depth (d) that are designed to receive and accommodate a portion of a clamp (not illustrated in FIGS. 2A-2C) while elevating it at a distance above the surface of a clamp alignment member 110B. This way, once a clamp is secured in the recess 136, the clamp will be elevated above the surface of a clamp alignment member 110B at a sufficient distance for the user to adjust the camp and have a clearance between the clamp alignment member 110B and the interconnection members that are coupled to the clamp alignment member 110B.

The upper portion 131B also defines transversely extending apertures 134A, 134B in each of the sidewalls 138A, 138B. Each aperture 134A, 134B is configured to accommodate a fastener 132A, 132B. The fasteners 132A, 132B can be inserted into the respective apertures 134A, 134B to secure and fasten a clamp (not illustrated in FIGS. 2A-2C) in a fixed position within the recess 136 that is defined by the sidewalls 138A, 138B. The type of fasteners 132A, 132B, 154 that are used can vary depending on the implementation. For example, in the embodiment that is illustrated in FIGS. 2A-2C, the fasteners 132A, 132B, 154 are set screws, but in other embodiments, the fasteners 132A, 132B, 154 can be, for example, shoulder bolts, dowel pins, tapered pins, keyed shafts, thumb knobs, quick release fasteners, etc.

While the embodiment illustrated in FIGS. 2A-2C shows the clamp holder portion 131 with two apertures 134A, 134B (i.e., one in each of the sidewalls 138A, 138B), it should be appreciated that in other embodiments, the clamp holder portion 131 may include fewer or more apertures depending on the configuration of the recess and the type of clamp that the clamp holder portion 131 is designed to be used with. For instance, in some embodiments, the clamp holder portion 131 includes no apertures, in other embodiments the clamp holder portion 131 may include one aperture, while in other embodiments the clamp holder portion 131 may include more than two apertures.

The supporting portion 152 includes an aperture 153 that is configured to align with the slot 116B so that it can receive the fastener 154. As such, the fastener 154 can be inserted through the aperture 153, through the slot 116B, and into the recess 134C that is defined in the clamp holder portion 131. When the fastener 154 is fully engaged with the supporting portion 152 and the clamp holder portion 131, as shown in in FIGS. 2A and 2C, the supporting portion 152 and the clamp holder portion 131 are secured with respect to the clamp alignment member 110B such that the clamp holder 130C is placed in a fixed or secured position with respect to the clamp alignment member 110B. In other words, in FIGS. 2A and 2C, the clamp holder portion 131 is secured to the supporting portion 152 via the fastener 154 to fix the position of the clamp holder 130C with respect to the clamp alignment member 110B.

When the fastener 154 is untightened, so that it is not fully engaged with clamp holder portion 131, the position of the clamp holder 130C can be adjusted and moved with respect to the slot 116B as indicated by the arrow A in FIG. 2A. For example, the fastener 154 may be partially loosened so that the clamp holder 130C is not locked in place with respect to the clamp alignment member 110B, which in turn allows the fastener 154 of the clamp holder 130C to slide within the slot 116B. This allows for the relative position of the clamp holder 130C to be moved longitudinally toward or away from the end 112B of the clamp alignment member 110B. The fastener 154 may then be tightened, to lock the clamp holder 130C in a fixed position with respect to the end 112B of the clamp alignment member 110B once the clamp holder 130C is in a desired position.

As described above, the one end 126A, 126B, 126C, 126D, 126E, 126F of each interconnection member 120A, 120B, 120C, 120C, 120D, 120E, 120F is rotationally and translatably coupled to one of the clamp alignment members 110A, 110B, 110C, 110D via the fastener 119A, 119B, 119C, 119D and the other end 128A, 128B, 128C, 128D, 128E, 128F of each interconnection member 120A, 120B, 120C, 120C, 120D, 120E, 120F may be rotatably coupled to another one of the clamp alignment members 110A, 110B, 110C, 110D via the fastener 122A, 122B, 122C, 122D. The fasteners 119 and 122 can vary depending on the implementation.

In some cases, the fasteners 119A, 122A, 119D, 122D couple a clamp alignment member 110A, 110D to a single interconnection member 120A, 120B, 120E, 120F, whereas in other cases, the fasteners 119B, 122B, 119C, 122C couple a clamp alignment member 110B, 110C to two interconnection members. For example, with reference to FIG. 1, the fastener 119A couples the clamp alignment member 110A to a single interconnection member 120A, and the fastener 122A couples the clamp alignment member 110A to a single interconnection member 120B. By contrast, the fastener 119B couples the clamp alignment member 110B to two interconnection members 120B, 120C, and the fastener 122B couples the clamp alignment member 110B to two interconnection members 120A, 120D.

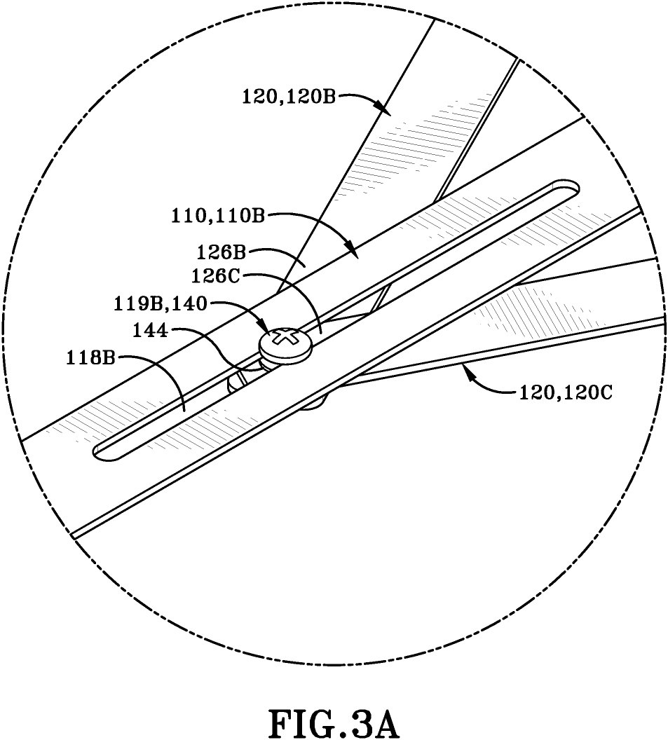

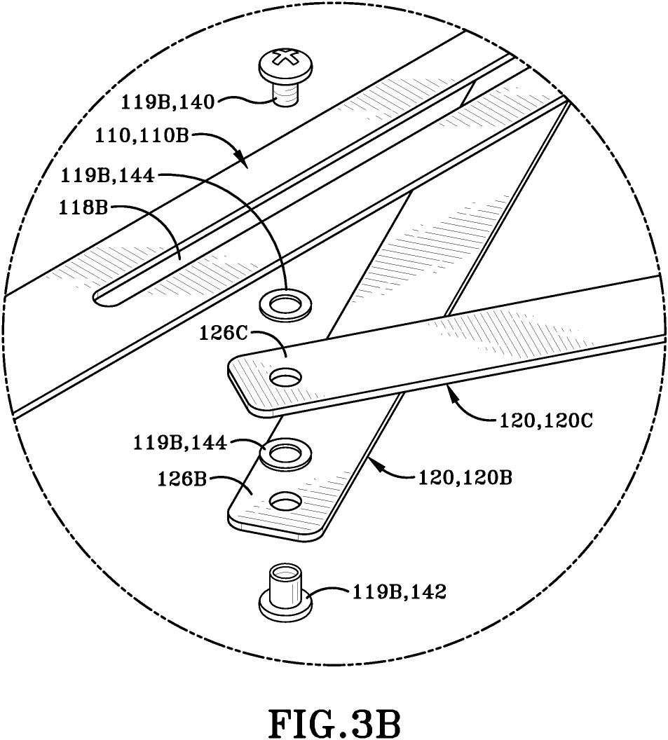

An example where the fastener 119B couples the clamp alignment member 110B to two interconnection members 120B, 120C will now be described with reference to FIGS. 3A and 3B, where FIG. 3A is an isometric perspective top view of the clamp alignment member 110B, the interconnection members 120B, 120C and the fastener 119B of the clamp holder system 100 of FIG. 1, and where FIG. 3B is an exploded isometric perspective top view of FIG. 3A. As described above, the fastener 119B connects the clamp alignment member 110B and the interconnection members 120B, 120C through slot 118B. The fastener 119B slidably and pivotably connects each of the ends 126B, 126C of the interconnection members 120B, 120C to slot 118B of the clamp alignment member 110B to allow the interconnection members 120B, 120C to slide freely along the longitudinal direction of the clamp alignment member 110B.

As shown in FIG. 3B, each of the interconnection members 120B, 120C include an aperture formed therein. In this embodiment, the fastener 119B includes top and bottom fastener elements 140, 142 and spacers 144. Bottom fastener element 142 may be inserted through the aperture formed in interconnection member 120B, through spacer 144, through the aperture formed in interconnection member 120C, through spacer 144 and then through slot 118B. Top fastener element 140 may then be inserted through slot 118B to engage the bottom fastener element 142 and then tightened so that top fastener element 140 is in threaded engagement with bottom fastener element 142.

Spacer 144 is sandwiched between the clamp alignment member 110B and the interconnection member 120C and serves to space the clamp alignment member 110B apart from the interconnection member 120C. Spacer 144 is sandwiched between the interconnection member 120C and the interconnection member 120B and serves to space the interconnection member 120C apart from the interconnection member 120B. Spacers 144 help facilitate the pivotability of the clamp alignment member 110B and the interconnection members 120B, 120C, and also help protect the surfaces of the clamp alignment member 110B and the interconnection members 120B, 120C from damage during the process of tightening the fastener 119B and when the fastener 119B slides within the slot 11B. In one embodiment, illustrated in FIG. 3B, the spacers 144 can be implemented using a matched pair of washers.

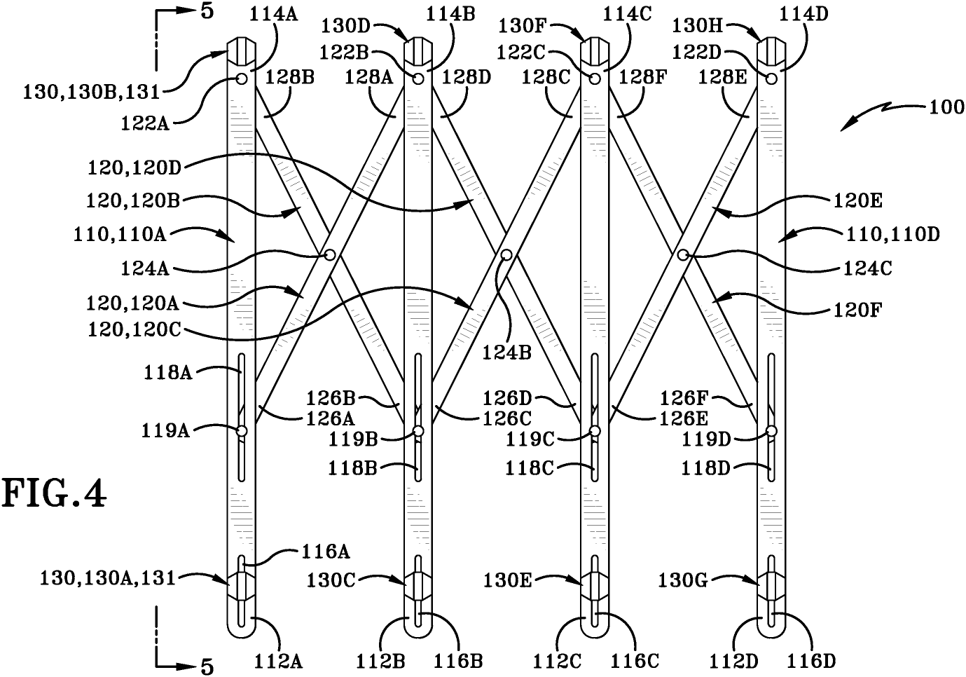

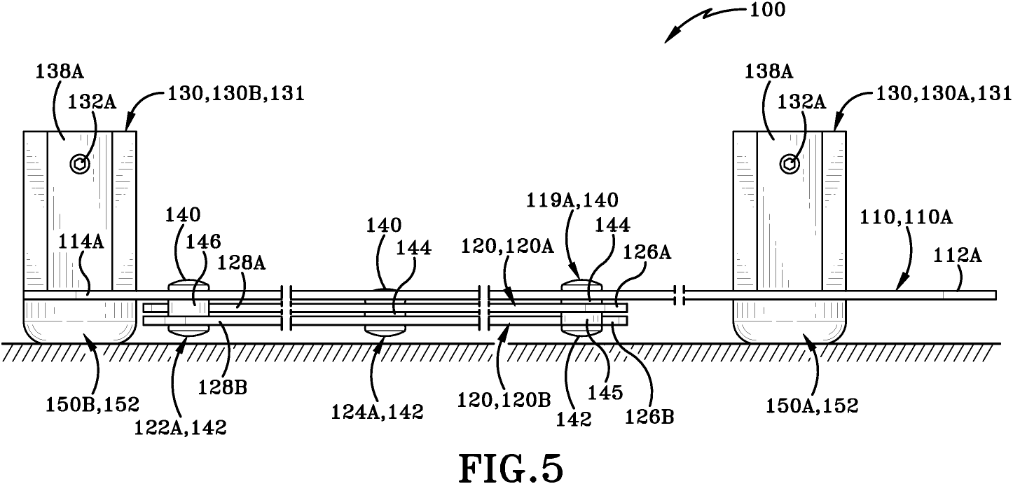

Referring again to FIG. 1, it should also be appreciated that the connecting features 124 that are used to connect two interconnection members 120 can also have a different interconnection structure in comparison to the fasteners 119, 122 that are used to connect a clamp alignment member 110 to interconnection members 120 as will now be explained with reference to FIGS. 4 and 5.

FIG. 4 is an isometric top view of an embodiment of the clamp holder system in accordance with an aspect of the present disclosure. The various elements in FIG. 4 are already described above with reference to FIG. 1 and for sake of brevity that description will not be repeated. FIG. 5 is a front elevation view of a portion of the clamp holder system 100 when viewed along line 5-5 of FIG. 4. The portion of the clamp holder system 100 shown in FIG. 5 the clamp alignment member 110A, the interconnection members 120A, 120B, fastener 122A, fastener 119A, the connecting feature 124A, and clamp holders 130A, 130B. The features of the clamp holders 130A, 130B in FIG. 5 are already described above with reference to FIGS. 2A-2C and for sake of brevity the description of those features will not be repeated here. Notably, as shown in FIG. 5, the fastener 122A, the fastener 119A, and the connecting feature 124A each have different spacer structures to achieve the desired spacing between the clamp alignment member 110A and the interconnection members 120A, 120B given their stacked layout configuration, as will now be explained in further detail with continued reference to FIG. 5.

To explain further with reference to the view illustrated in FIG. 5 when viewing from top of the page to the bottom of the page, the clamp alignment member 110A is above member 120A, the interconnection member 120A is positioned below the clamp alignment member 110A and in between the clamp alignment member 110A and the interconnection member 120B, and the interconnection member 120B is positioned below the interconnection member 120A and the clamp alignment member 110A.

The fastener 122A connects the end 114A of the clamp alignment member 110A to the end 128B of the interconnection member 120B. The fastener 122A includes the top fastener element 140, a spacer 146, and the bottom fastener element 142. The connecting feature 124A connects the interconnection members 120A, 120B. The connecting feature 124A includes the top fastener element 140, the spacer 144, and the bottom fastener element 142. The fastener 119A connects the clamp alignment member 110A to the end 126A of the interconnection member 120A. The fastener 119A includes the top fastener element 140, the spacer 144, the spacer 145 and the bottom fastener element 142.

Due to the relative layout of the clamp alignment member 110A and the interconnection members 120A, 120B and the way in which they are stacked relative to each other (as described above), the fastener 122A, the fastener 119A and the connecting feature 124A utilize different numbers of spacers, some of which have different thicknesses and/or top-to-bottom ordering, to achieve the desired spacing between the clamp alignment member 110A and the interconnection members 120A, 120B.

For example, the fastener 122A, the fastener 119A and the connecting feature 124A each include the top fastener element 140 and the bottom fastener element 142. However, the fastener 122A also includes the spacer 146, whereas the fastener 119A also includes a combination of two distinct spacers, namely, the spacer 144 and the spacer 145, and the connecting feature 124A also includes the spacer 144. The spacer 145, which is between clamp alignment member 110A and the interconnection member 120A, is much thicker than spacer 144. Similarly, the spacer 146, which is between clamp alignment member 110A and the interconnection member 120B, is also much thicker than spacer 144. The use of these thicker spacers 145, 146 and their relative arrangement allows for proper clearances to be achieved between the clamp alignment member 110A and the interconnection members 120A, 120B. By appropriately defining these clearances the clamp holder system 100 may be expanded and contracted such that the clamp alignment members 110 and the interconnection members 120 move freely without contacting each other.

As will now be explained below with reference to FIGS. 6A and 6B, the clamp holder system 100 is configured to be movable between a first position and a second position. In one embodiment, the system repeatably moves between a fully expanded position and a fully retracted position. The clamp holder system 100 may be expanded or retracted so that it is configured in any configuration between the fully expanded position and the fully retracted position. FIG. 6A is an isometric perspective top view of the clamp holder system 100 of FIG. 1 when it is in a fully retracted position and is expandable (i.e., a first position). FIG. 6B is an isometric perspective top view of the clamp holder system 100 of FIG. 1 when it is in a fully expanded position and retractable (i.e., a second position). The various elements in FIGS. 6A and 6B are already described above with reference to FIG. 1 and for sake of brevity the description of those elements will not be repeated.

Referring to FIG. 6A, when the clamp holder system 100 is in the fully retracted position, as indicated by the arrows labeled R, a separation distance (SD1) between each of the clamp alignment members 110A, 110B, 110C, 110D is at a minimum or near minimum. In this fully retracted position, each of the ends 126A, 126B, 126C, 126D, 126E, 126F of each of the interconnection members 120A, 120B, 120C, 120C, 120D, 120E, 120F are positioned along the slots 118A, 118B, 118C, 118D to one maximum extent, or near maximum extent. For example, the fasteners 119A, 119B, 119C, 119D, which are moveable and adjustable in their position within the slots 118A, 118B, 118C, 118D, are positioned at one end of the slots 118A, 118B, 118C, 118D.

From this fully retracted position, the clamp alignment members 110A, 110B, 110C, 110D of the clamp holder system 100 can be repositioned so that the separation distance (SD1) between the clamp alignment members 110A, 110B, 110C, 110D is increased up to a maximum, or near maximum, separation distance (SD2), as shown in FIG. 6B, which illustrates the clamp holder system 100 in the fully expanded position, as indicated by the arrows labeled E. In this fully expanded position, each of the ends 126A, 126B, 126C, 126D, 126E, 126F of each of the interconnection members 120A, 120B, 120C, 120C, 120D, 120E, 120F are moved along the slots 118A, 118B, 118C, 118D to another maximum extent, or near maximum extent. For example, the fasteners 119A, 119B, 119C, 119D are positioned at another end of the slots 118A, 118B, 118C, 118D.

It should be appreciated that the clamp holder system 100 can be adjusted so that separation distance between each of the clamp alignment members 110A, 110B, 110C, 110D is any separation distance between the minimum separation distance (SD1) and the maximum separation distance (SD2). As such, the ends 126A, 126B, 126C, 126D, 126E, 126F of each of the interconnection members 120A, 120B, 120C, 120C, 120D, 120E, 120F can be positioned anywhere along the slots 118A, 118B, 118C, 118D. The pivotable and rotatable coupling of the ends 126, 128 of the interconnection members 120 to the clamp alignment members 110, along with the ability of the fasteners 119 to translate or move along the slots 118, allows for the clamp holder system 100 to be easily adjusted so that the separation distance between clamp alignment members 110A, 110B, 110C, 110D can be easily set as desired to any separation distance between the minimum separation distance (SD1) and the maximum separation distance (SD2).

Regardless of the separation distance, the clamp alignment members 110A, 110B, 110C, 110D remain equally spaced apart with respect to each other. The ability to automatically and consistently set the separation distance between the clamp alignment members 110A, 110B, 110C, 110D by making a simple adjustment to one of the clamp alignment members can be beneficial to a user of the clamp holder system 100. For example, once clamps are secured by the clamp holders 130, it allows a user to easily adjust the spacing between the clamps so that they remain equally (or substantially equally) spaced apart with respect to each other.

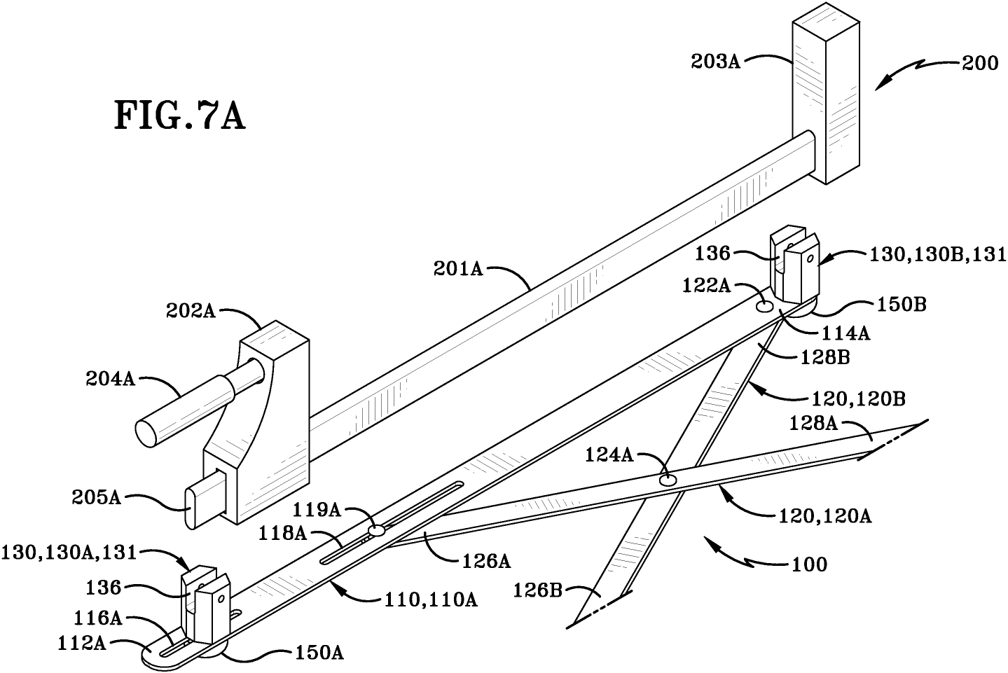

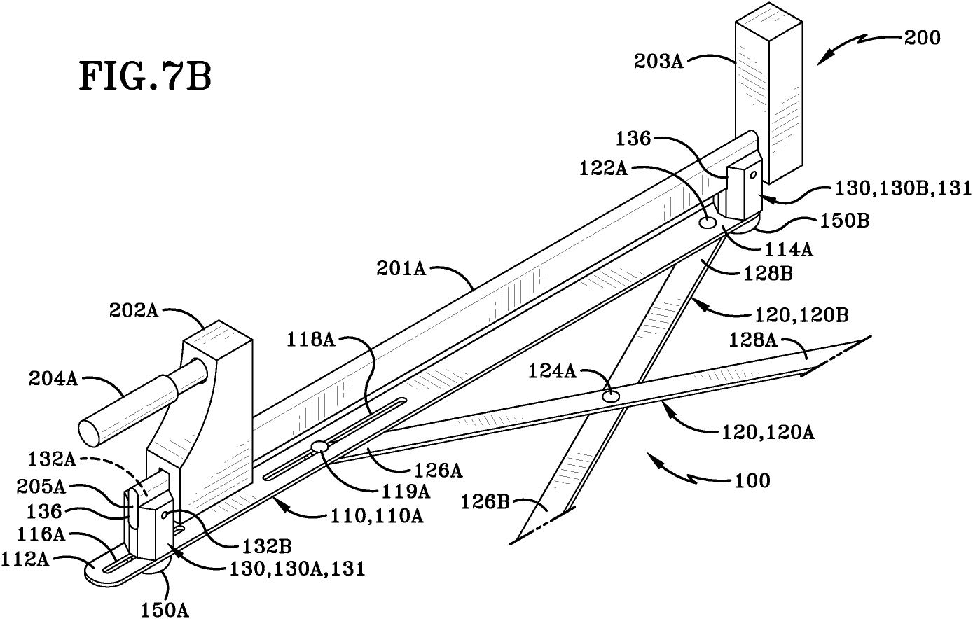

FIG. 7A is an isometric perspective top view of a portion of the clamp holder system 100 of FIG. 1 and a clamp 200 that will eventually be engaged by the clamp holder system 100. FIG. 7B is an isometric perspective top view of the portion of the clamp holder system 100 that is shown in FIG. 7A with the clamp 200 securely engaged by the clamp holder system 100. The various elements of the clamp holder system 100 in FIGS. 7A and 7B are already described above with reference to FIG. 1-6B and for sake of brevity the description of those elements will not be repeated.

As shown in FIG. 7A, clamp 200 is parallel clamp, which may also be referred to as a bar clamp. Clamp 200 includes a guiding member 201A, a sliding member 202A, a fixed member 203A and a handle 204A on the sliding member 202A that may be used to move the sliding member 202A along the length of the guiding member 201A. The guiding member 201A is a rectangular bar, and the sliding member 202A serves as one of two parallel clamping jaws, with the fixed member 203A serving as the other clamping jaw. The handle 204A is a screw-based mechanism that can be actuated, for example, by turning it clockwise to move the sliding member 202A closer to the fixed member 203A, or by turning it counterclockwise to move the sliding member 202A further away from the fixed member 203A. It should be noted that the clamp 200 shown in this example is simply one non-limiting example of one type of clamp that the clamp holder system 100 may be used with. In this regard, the clamp holder system 100 may be used with a wide variety of different types of clamps, such as toggle clamps, spring clamps, C-style clamps, F-style clamps, G-style clamps, pipe clamps, and other types of parallel clamps to name a few non-limiting examples

As shown in FIG. 7B, the clamp 200 may be inserted into the recesses 136 of the clamp holders 130A, 130B. For example, end 205A of the guiding member 201A may be inserted into the recess 136 of clamp holder 130A, and another portion of the guiding member 201A can be inserted into the recess 136 of clamp holder 130B. The guiding member 201A may then be securely fixed in place by tightening fasteners 132A, 132B that are in each of the clamp holders 130A, 130B, which can be implemented as set screws in one non-limiting embodiment. The clamp holders 130A, 130B elevate the clamp 200 at a distance above the surface of the clamp alignment member 110A so that the clamp 200 does not contact with the clamp alignment member 110A.

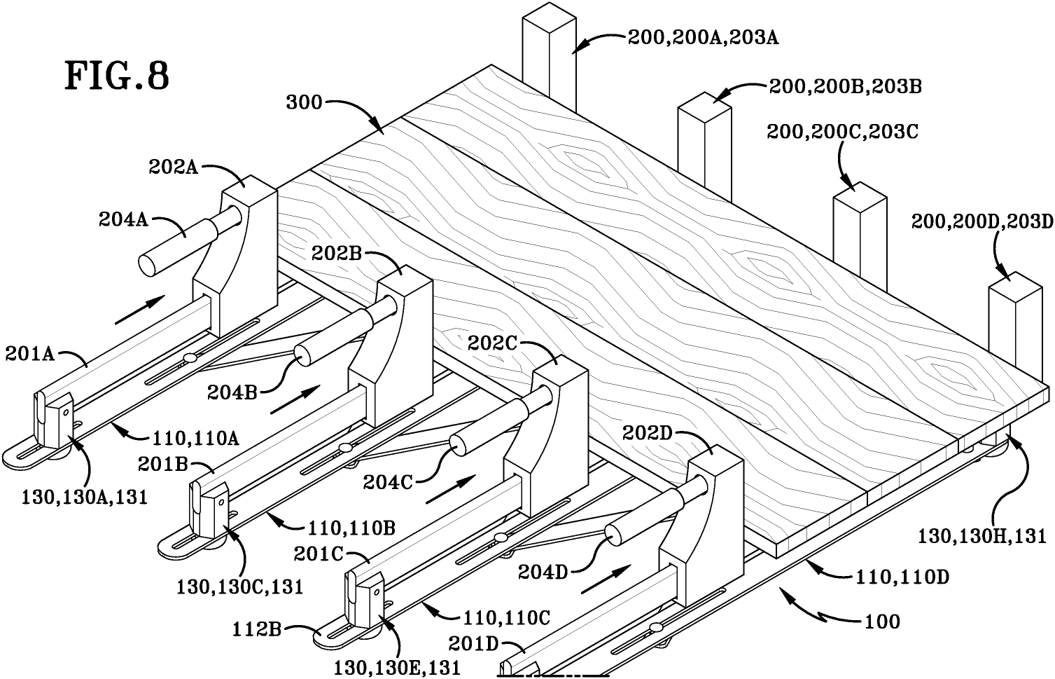

Parallel clamps, such as clamp 200, are particularly useful for clamping pieces of wood together as they can apply a lot of clamping force over a large area. FIG. 8 is an isometric perspective top view of the clamp holder system 100 of FIG. 1 with a set of clamps 200A, 200B, 200C, 200D engaged by the clamp holder system 100 and being used to clamp a number of wooden pieces 300 together. The various elements of the clamp holder system 100 in FIG. 8 are already described above with reference to FIG. 1-6B and for sake of brevity the description of those elements will not be repeated. Likewise, the various elements of a clamp 200 in FIG. 8 are already described above with reference to FIGS. 7A-7B and for sake of brevity the description of those elements will not be repeated.

As shown in FIG. 8, clamps 200A, 200B, 200C, 200D may include sliding members 202A, 202B, 202C, 202D, guiding members 201A, 201B, 201C, 201D, and fixed members 203A, 203B, 203C, 203D. As indicated by the arrows, the sliding members 202A, 202B, 202C, 202D have been moved forward using handles 204A, 204B, 204C, 204D to slide along the length of the guiding members 201A, 201B, 201C, 201D, and thus securely hold the wooden pieces 300 between the sliding members 202A, 202B, 202C, 202D and the corresponding fixed members 203A, 203B, 203C, 203D.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/-0.1% of the stated value (or range of values), +/-1% of the stated value (or range of values), +/-2% of the stated value (or range of values), +/-5% of the stated value (or range of values), +/-10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method for an apparatus for holding clamps, the apparatus having a plurality of interconnection members and a plurality of clamp alignment members coupled to each other via the plurality of interconnection members, wherein each interconnection member is translatably coupled to one of the clamp alignment members and rotatably coupled to an adjacent one of the clamp alignment members, the method comprising:
coupling a first clamp to a first clamp alignment member;
coupling a second clamp to a second clamp alignment member;
moving the first clamp and the second clamp from a first position to a second position, wherein moving the first clamp and the second clamp relative to one another is accomplished by translating a first end of a first interconnection member in an axial direction relative to the first clamp alignment member and rotating a second end of the first interconnection member relative to the second clamp alignment member; and
clamping an item with the first clamp and the second clamp after having moved the first clamp and the second clamp from the first position to the second position.

2. The method of claim 1, further comprising:
sliding a fastener at the first end of the first interconnection member within a slot defined in the first clamp alignment member.

3. The method of claim 1, further comprising:
moving a second interconnection member in a scissoring action relative to the first interconnection member.

4. The method of claim 3, further comprising:
translating a first end of the second interconnection member in an axial direction relative to the second clamp alignment member and rotating a second end of the second interconnection member relative to the first clamp alignment member.

5. An apparatus for holding clamps, the apparatus comprising:
a plurality of interconnection members; and
a plurality of clamp alignment members coupled to each other via the plurality of interconnection members, wherein each interconnection member is translatably coupled to one of the clamp alignment members and rotatably coupled to an adjacent one of the clamp alignment members.

6. The apparatus according to claim 5, wherein each one of the clamp alignment members comprises one of a slot and a fastener, wherein the slot and the fastener to allow an end of one of the plurality of interconnection members to translate relative to a first clamp alignment member.

7. The apparatus according to claim 6, wherein the slot is formed adjacent one end of one of the clamp alignment members to cause the fastener connected to the end of one of the plurality of interconnection members to slide in an axial direction of the clamp alignment member, and wherein the end of each interconnection member is rotationally and translatably coupled to that clamp alignment members via the fastener disposed in the slot to which the interconnection member is coupled.

8. The apparatus according to claim 7, wherein the fastener is a first fastener that is translatably coupled for movement within the slot formed in one of the clamp alignment members to allow for movement of the first fastener and the interconnection member along an axis defined by one of the clamp alignment members to which the interconnection member is coupled;
wherein each of the plurality of clamp alignment members comprises a first end and a second end, wherein the slot is a first slot, and wherein each of the clamp alignment members further defines a second slot formed therein; and
wherein another end of each interconnection member is rotatably coupled to the second end of one of the clamp alignment members through a second fastener.

9. The apparatus according to claim 5, wherein the plurality of interconnection members are configured to be movable between a first position and a second position, wherein the first position corresponds to an expanded position of the apparatus and the second position corresponds to a retracted position of the apparatus in which a separation distance between the clamp alignment members is less than the separation distance between the clamp alignment members when the interconnection members are in the expanded position of the apparatus.

10. The apparatus according to claim 5, further comprising:
a plurality of clamp holders each being coupled to at least one of the clamp alignment members.

11. The apparatus according to claim 10, wherein each one of the clamp alignment members defines a slot formed therein along an axial direction of the clamp alignment member, and wherein the plurality of clamp holders comprise:
a first clamp holder for each one the clamp alignment members, each first clamp holder coupled to a slot of the clamp alignment member that the first clamp holder is coupled.

12. The apparatus according to claim 11, wherein a position of the first clamp holder is adjustable within the slot of the clamp alignment member that the first clamp holder is coupled, and wherein the plurality of clamp holders, further comprise:
a second clamp holder, wherein the first clamp holder is movable and the second clamp holder is fixed relative to the clamp alignment member.

13. The apparatus according to claim 11, wherein the slot is a first slot, wherein each of the clamp alignment members further defines a second slot formed therein, and wherein the first clamp holder comprises:
a clamp holder portion;
a supporting portion; and
a fastener that extends through the supporting portion and the second slot into the clamp holder portion to couple the supporting portion to the clamp holder portion.

14. The apparatus according to claim 5, wherein each interconnection member is rotatably coupled to another interconnection member to form an interconnection member pair.

15. The apparatus according to claim 5, wherein each interconnection member of an interconnection member pair is pivotably coupled to the other interconnection member of that interconnection member pair to allow for rotation of the interconnection members relative to each other.

16. A clamp holder system comprising:
a plurality of clamp alignment members, wherein each of the plurality of clamp alignment members comprises a first end and a second end;
a plurality of interconnection members connecting at least one clamp alignment member of the plurality of clamp alignment members to an adjacent clamp alignment member of the plurality of clamp alignment members;
wherein each interconnection member is pivotably coupled to another interconnection member of the plurality of interconnection members; and
wherein each of the plurality of interconnection members is slidably coupled with respect to one of the plurality of clamp alignment members.

17. The clamp holder system according to claim 16, further comprising:
a slot defined between the first end and the second end in each clamp alignment member;
wherein each of the plurality of interconnection members is slidably coupled with respect to one of the plurality of clamp alignment members via one of the slots in each in the clamp alignment members.

18. The clamp holder system according to claim 17, further comprising:
a plurality of clamp holders disposed along at least one of the plurality of clamp alignment members.

19. The clamp holder system according to claim 18, wherein the slot is a first slot, and
wherein each of the plurality of clamp alignment members further comprises a second slot, and wherein the plurality of clamp holders comprise:
a movable clamp holder slidably coupled within the second slot at each of the clamp alignment members.

20. The clamp holder system according to claim 19, wherein the plurality of clamp holders further comprise:
a fixed clamp holder coupled to each of the plurality of the clamp alignment members.

21. The clamp holder system according to claim 20, wherein each of the movable clamp holder and the fixed clamp holder comprises:
a clamp holder portion comprising a pair of sidewall portions that are spaced apart to define a recess within the clamp holder portion, the recess being configured to receive a clamp and elevate the clamp at a distance above a first surface of a clamp alignment member to which the clamp holder portion is coupled;
a supporting portion;
a fastener that extends through the supporting portion and the second slot into the clamp holder portion to couple the supporting portion to the clamp holder portion; and
wherein the clamp holder portion is configured to receive one or more adjustable set screws to fasten the clamp in a fixed position within the clamp holder portion.

22. The clamp holder system according to claim 17, wherein a position of each movable clamp holder is adjustable along the slot to move the clamp holder in an axial direction of a clamp alignment member that the movable clamp holder is coupled to, and wherein each interconnection member is pivotably coupled to an end portion of a clamp alignment member to allow the interconnection member to rotate with respect to a longitudinal axis of that clamp alignment member.

23. The clamp holder system according to claim 17, wherein each of the plurality of interconnection members is slidably coupled with respect to one of the plurality of clamp alignment members via one of the slots such that movement of the clamp alignment members in a first direction results in expansion of the clamp holder system and movement of the clamp alignment members in a second direction, opposite the first direction, results in retraction of the clamp holder system.

24. The clamp holder system according to claim 16, wherein each interconnection member of the plurality of interconnection members further comprises a first aperture formed therein for coupling that interconnection member to one of the clamp alignment members via a fastener.
